(19) United States
(12) Patent Application Publication
(10) Pub. No.: US 2016/0021846 A1
(43) Pub. Date: Jan. 28, 2016

(54) Pet Bed With Built-In Attached Blanket Cover

(71) Applicant: Jeffry John Bigott, Naperville, IL (US)

(72) Inventor: Jeffry John Bigott, Naperville, IL (US)

(21) Appl. No.: 14/339,381

(22) Filed: Jul. 23, 2014

(51) Int. Cl. A01K 1/035; A47G 9/02

(52) U.S. Cl. CPC A01K 1/0353; A47G 9/0223

(57) ABSTRACT

A resting place for dogs or other pets consisting of a soft covered foam wall, with an attached blanket cover to keep the animal warm and secure. Made of only a few separate components including the foam inner wall, detachable zipped wall cover with attached blanket and floor and removable cushioned pillow. The blanket cover is attached to approximately 75% of the wall covering's top periphery, regardless if it is of a square or rectangular shape, or if it's circumference is of a rounded or oval shape. This removable wall cover with attached blanket also has an attached floor that completes the wall enclosure's bottom through a periphery zipper, securing the complete wall covering to the internal foam padded wall. Collectively, the detachable zipped wall cover with attached blanket and floor, is tucked, and then zipped, over the foam wall, creating a completely supported pet bed structure. A removable cushioned pillow is stuffed and inserted between upper topside attached blanket and lower bottom side floor to act as a soft resting place and floor cushion. The front wall cut-out is the open and unattached portion of the blanket cover that creates an entrance for easy pet access and escape.

### FIELD OF INVENTION

This invention is directed to a new and improved bed or resting place for dogs and other pets.

### BACKGROUND

### Description of Prior Art

Various pet beds have been proposed. A common problem with dog and pet beds is providing a blanket or cover for the animal that will stay in place and give the animal an easy way to keep itself covered. Some beds provide overhead protection with little or no direct warming contact. Thus there exists a need for an easy to use, machine washable pet bed with built-in blanket cover.

The Dog Bed in U.S. Pat. No. 3,989,008 shows a bed having a similar function, but is of quite complex design and difficult to disassemble for cleaning.

The Pet Sleeping Bag in U.S. Pat. No. 4,169,428 also has a similar function, but lacks the ease of entry into the bag.

The Pet Bed and Enclosure in U.S. Pat. No. 5,072,694 provides easy access, but does not collapse around the pet like a blanket, nor can it disassembled for easy cleaning.

The Pet Enclosure in U.S. Pat. No. 5,282,439 suffers from the same problems as the previously cited art.

### OBJECTS AND ADVANTAGES

Accordingly, there are several objects and advantages of this invention. The object of this design is to provide a comfortable bed for the dog or pet to sleep or rest upon, to provide an attached blanket to keep the animal covered that is secured in place, and to provide easy access into and onto the bed and under the blanket. The removable one piece zip-off cover with attached blanket provides easy assembly, disassembly and removal for cleaning and machine wash.

### DRAWING FIGURES

FIGS. 1-4 show various aspects of the Pet Bed with Built-In Attached Blanket Cover.

FIG. 1 shows a TOP view.

FIG. 2 shows a SIDE view.

FIG. 3 shows a FRONT view.

FIG. 4 shows a PERSPECTIVE view.

### REFERENCE NUMERALS IN THE DRAWING

10 inside covered foam pad
12 zipped detachable cover
14 attached built-in blanket
16 secured bed floor with zipper
18 front entrance with cut-out
20 removable pillow cushion

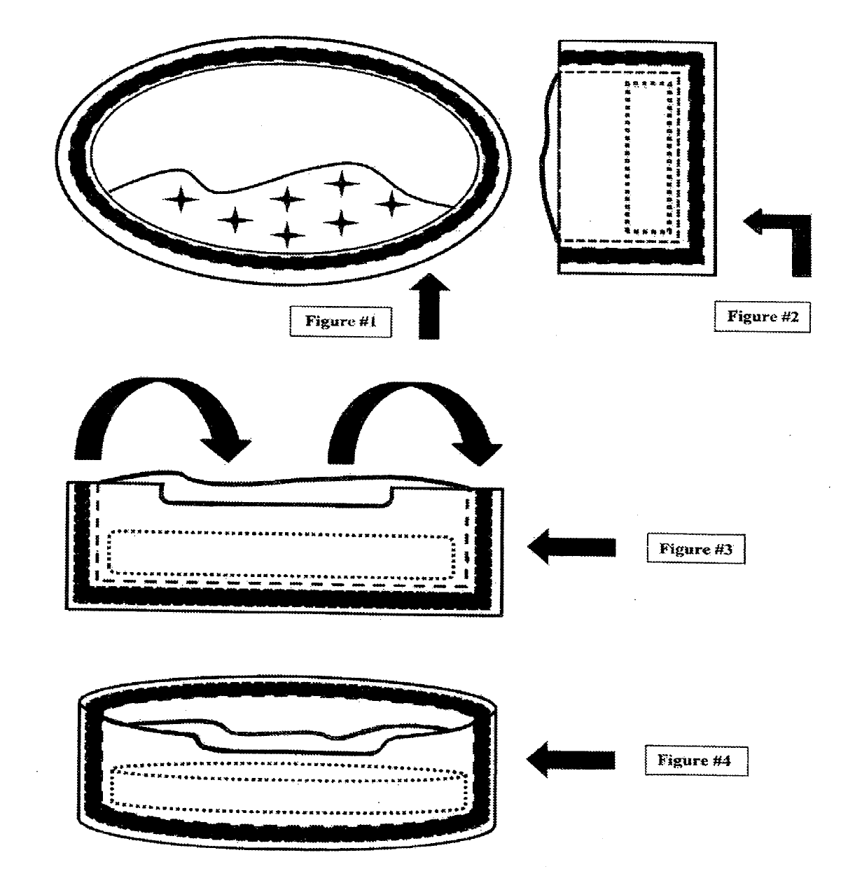

A typical embodiment of the present invention is illustrated in FIGS. 1 through 4. The bed primarily consists of (3) three simple components. A 1½ internal foam wall (10) used as wall support for the bed. A detachable and removable zip-on wall cover (12) with attached blanket (14) and secured bed floor with zipper (16). Both the foam wall and detachable cover include a front cut-out (18) that makes easy access and escape for all pets including those that are small, older and disabled. The manner of use of this invention is simply for the dog or pet to burrow under the attached blanket cover and through the front cut-out entrance to rest atop the inserted pillow cushion (20) and sleep while automatically staying covered. Also, in warmer weather, the animal can simply rest or sleep on top of the blanket cover.

### SUMMARY RAMIFICATIONS AND SCOPE

### Operation

Accordingly the reader will see that this invention allows for a comfortable resting place, has a soft covering to keep the animal warm during cooler weather, allows easy access under the blanket or covering, and is easily machine washable.

Although this description above contains many specificities, these should not be construed as the limiting the scope of the invention but as merely providing illustrations of the presently preferred embodiment of this invention. For example, the overall shape of the foam wall and removable wall cover can be of different shapes such as square, rectangular, circular or oval. Thus the scope of this invention should be determined by the appended claims and their legal equivalents, rather than by the examples given.

I claim:

1. A pet bed comprising:
a set of simple components that work together and configured to receive a covered pet in a sleeping position,
a. built-in and attached blanket cover that is secured to approximately 75% of the top periphery that creates an overlying layer atop the removable zip-on wall covering.
b. removable zip-on wall covering that consists of the wall covering material wrap, the attached blanket and a secured floor with zipper running to approximately 100% of the bottom periphery that shrouds and closes the wall covering to the internal foam wall.
c. removable foam wall component used to provide internal support for the pet bed.
d. front wall cut-out that makes easy access and escape for all pets including those that are small, older and disabled.

2. The pet bed of claim 1 wherein:
said detachable foam wall covering is formed of washable material.

3. The pet bed of claim 1 wherein: said internal wall is formed of foam.

4. The pet bed of claim 1 wherein: said blanket is formed of high map washable material.
